(19) United States
(12) Patent Application Publication
(10) Pub. No.: US 2026/0210250 A1
(43) Pub. Date: Jul. 23, 2026

(54) "STRESS-DISPLACEMENT" INTELLIGENT EARLY WARNING METHOD FOR ROOF DISASTER

(71) Applicant: Guizhou University, Guiyang (CN)

(72) Inventors: Zhijie WEN, Guiyang (CN); Zhongfu CHEN, Guiyang (CN); Zhenqi SONG, Guiyang (CN); Qingshui MA, Guiyang (CN); Wentao REN, Guiyang (CN); Huangbao YAN, Guiyang (CN); Pengfei JIANG, Guiyang (CN); Yuanqing OU, Guiyang (CN); Zhizhong JIANG, Guiyang (CN)

(21) Appl. No.: 19/449,872

(22) Filed: Jan. 15, 2026

(30) Foreign Application Priority Data
Jan. 17, 2025 (CN) 202510079096.3

(51) Int. Cl. E21F 17/18; E21D 20/00; G01V 99/00

(52) U.S. Cl. CPC E21F 17/185; E21D 20/00; G01V 99/00

(57) ABSTRACT

Provided is a “stress-displacement” intelligent early warning method for roof disaster, which relates to the technical field of coal mine engineering safety and support. The method includes:
establishing a stress-time database and a displacement-time database, and arranging early warning modules in the corresponding databases; collecting the stress-time and displacement-time in real time by sensors, and transmitting the data to the data processor; uploading the processed data to the stress-time database and displacement-time database, dynamically matching the processed data with the early warning module in the database, and then converting it into early warning signals for warning. It follows the principle of “stress-displacement” synchronization, and significantly improves the accuracy of early warning by comprehensively monitoring the stress and displacement of the roof separation layer.

### CROSS-REFERENCE TO RELATED APPLICATIONS

This application claims priority to Chinese Application No. 202510079096.3, filed on Jan. 17, 2025, entitled “STRESS-DISPLACEMENT INTELLIGENT EARLY WARNING METHOD FOR ROOF DISASTER”. These contents are hereby incorporated by reference.

### TECHNICAL FIELD

The present disclosure relates to the technical field of coal mine engineering safety and support, in particular to to a “stress-displacement” intelligent early warning method for roof disaster.

### BACKGROUND

The stability of the tunnel roof is crucial for safe production in the process of coal resource mining. With the continuous redistribution of stress in the surrounding rock of the tunnel, local delamination and deformation of the roof may occur, which may lead to safety accidents such as roof collapse in severe cases. In order to ensure the stability of the roof, anchoring rods (anchoring cables) are mainly used for support, and most of the existing monitoring methods are based on the stress state of anchoring rods (anchoring cables) or the single parameter of roof deformation. After obtaining monitoring data, it is difficult to effectively utilize the data due to the lack of corresponding discrimination criteria. Therefore, it is necessary to establish corresponding early warning models, perform real-time matching analysis on the collected data, accurately identify the state of the roof, capture the multi-level changes of the roof, and provide accurate early warnings before the development of separated layer and instability of anchoring force.

In Application number 201911170436.4, it discloses a monitoring and early warning system for deep soft coal rock burst disasters and an early warning method thereof. The system includes a stress sensor for detecting the pressure value of the drilling holes and a displacement sensor for detecting the displacement value generated when the deformation of the tunnel wall occurs. The system also includes three stress early warning signals, namely the first green early warning, the first yellow early warning, and the first red early warning, two stress early warning pressure values, namely the first early warning pressure value and the second early warning pressure value, three displacement early warning signals, namely the second green early warning, the second yellow early warning, and the second red early warning, and two stress early warning pressure values, namely the first early warning pressure value and the second early warning pressure value. The stress early warning indicators issue corresponding stress early warnings based on displacement values, so that comprehensive data on drilling pressure values and tunnel deformation can be used for early warning issuance.

The above-mentioned prior art achieve early warning through monitoring pressure value and displacement value, but the warning methods emphasize threshold warning based on pressure values and do not clearly indicate the relationship between stress and displacement changes. However, displacement and stress can change synchronously on site, such as under specific geological conditions (such as soft rock tunnels, deep mining environments, and local pressure relief zones), the stress and displacement of the coal mine roof can exhibit synchronous changes. Specifically, when the stress on the roof layer reaches a certain level, stress redistribution and deformation response occur almost simultaneously. Therefore, for the situation where stress and displacement change synchronously, the existing prediction methods are not feasible, and the prediction accuracy still needs to be further improved.

### SUMMARY

The present disclosure aims to provide a “stress-displacement” intelligent early warning method for roof disaster, which follows the principle of “stress-displacement” synchronization, and significantly improves the accuracy of early warning through dual monitoring means and comprehensive monitoring of stress and displacement of the roof separation layer.

In order to achieve the above objectives, the present disclosure adopts the following technical solution: A “stress displacement” intelligent early warning method for roof disaster, including the following steps:
(1) establishing a stress-time database and a displacement-time database based on the relationship between stress and time of roof separation layer, as well as the relationship between displacement and the time of the roof separation layer.
(2) Collecting stress-time and displacement-time in real time through a sensor, and transmitting the collected data to corresponding data processors;
(3) Arranging four early warning modules in the stress-time database, namely a stress stability module, a stress slow development module, a stress separated layer development module, and a stress separated layer instability module, wherein the stress stability module refers to an anchoring force not changing with time, the stress slow development module refers to the anchoring force slowly increasing with time, the stress separated layer development module refers to the anchoring force increasing in a jumping manner, and the stress separated layer instability module refers to the anchoring force decreasing abruptly;

Arranging four early warning modules in the displacement-time database, namely an overall stability module, a first separated layer development module, a second separated layer development module, and a separated layer instability module, wherein the overall stability module refers to the displacement strain not changing with time, the first separated layer development module refers to the displacement strain slowly increasing and tending to stabilize, the second separated layer development module refers to the displacement strain increasing in a jumping manner, and the separated layer instability module refers to the displacement strain increasing exponentially;
(4) After processing the data through a data processor, uploading the processed data to the stress-time database and the displacement-time database for carrying out dynamic matching with the four early warning modules in each database, and then transforming into early warning signals for warning.

The “stress-displacement” intelligent early warning method for roof disaster mentioned above, in step (2), installing sensors on an anchor rod or an anchor cable, which are arranged within a tunnel roof; the sensors include a stress sensor and a displacement sensor, with the stress sensor collecting real-time stress-time data and the displacement sensor collecting real-time displacement-time data.

The “stress-displacement” intelligent early warning method for roof disaster mentioned above, arranging drilling holes in a roof stratum of a tunnel, and installing the anchor rod or the anchor cable in the drilling holes, the stress sensor is fixed at a tail end of the anchor rod or the anchor cable.

The “stress-displacement” intelligent early warning method for roof disaster mentioned above, in step (3), transforming into early warning signals for warning through an early warning release terminal.

The “stress-displacement” intelligent early warning method for roof disaster mentioned above, in step (3), the stress stability module indicates that a roof stratum is stable; the stress slow development module indicates that a support system of the roof stratum is beginning to bear stress and requires monitoring and observation; the stress separated layer development module indicates that a structure of the roof stratum has undergone drastic changes and there are hidden dangers; the stress separated layer instability module indicates the support system is invalid and a danger level is high.

The “stress-displacement” intelligent early warning method for roof disaster mentioned above, in step (3), the overall stability module indicates that there is no obvious separation of roof stratum; the first separated layer development module indicates that there is slight deformation in the roof stratum, but still in a controllable state; the second separated layer development module indicates that rapid development of the separated layer and the risk of instability increases; the separated layer instability module indicates an increasing trend of rock instability and a high risk of collapse.

Compared with the prior art, the advantageous effects of the present disclosure are as following: (1) By comprehensively monitoring the stress and displacement of the roof separation layer, a comprehensive analysis of the support system and rock state is achieved, which makes up for the limitations of traditional single monitoring method and significantly improves the accuracy of early warning.
(2) The monitoring results is divided into eight detailed situations, which can more accurately judge the state of the roof and predict the trend and risk of roof deformation and instability.
(3) According to the change of geological conditions, the monitoring strategy and mode threshold is flexibly adjusted, which is suitable for soft rock, hard rock and deep mining.
(4) The present disclosure provides a scientific basis for decision-making by mine management personnel, reducing casualties and equipment damage caused by accidents such as collapses, thereby ensuring the safety production of mines.

### BRIEF DESCRIPTION OF THE DRAWINGS

FIG. 1 is a schematic diagram of the layout of roof separation layer disasters under stress-time monitoring.

FIG. 2 is the graphical analysis diagram of four warning modules, where (a) is the graphical analysis diagram of the stress stability module; (b) is the graphical analysis diagram of the stress slow development module; (c) is the graphical analysis diagram of stress separated layer development module; (d) is the graphical analysis diagram of the stress separated layer instability module.

FIG. 3 is a schematic diagram of the layout of roof separation layer disasters under displacement-time monitoring.

FIG. 4 is the graphical analysis diagram of four warning modules, where (a) is the graphical analysis diagram of the overall stability module; (b) is the graphical analysis diagram of the first separated layer development module; (c) is the graphical analysis diagram of the second separated layer development module; (d) is the graphical analysis diagram of the separated layer instability module.

FIG. 5 is a schematic diagram of the intelligent warning method for roof separation layer disasters.

Reference numbers in the drawings: 1—stress sensor; 2—drilling hole; 3—roof stratum; 4—coal seam; 5—tunnel; 6—anchor rod; 7—four early warning modules in the stress-time database; 71—stress stability module; 72—stress slow development module; 73—stress separated layer development module; 74—stress separated layer instability module; 8—deep anchoring point of displacement sensor; 9—four early warning modules in the displacement-time database; 91—overall stability module; 92—first separated layer development module; 93-second separated layer development module; 94—separated layer instability module; 10—shallow anchoring point of displacement sensor; 11—displacement sensor; 12—stress-time database and displacement-time database; 13—early warning release terminal.

### DETAILED DESCRIPTION OF THE EMBODIMENTS

In order to make the technical problems, technical solutions and beneficial effects of the present invention clearer, the present invention will be further described in detail below with reference to the accompanying drawings and embodiments.

The main technical concept of this application is: the collected data is processed through stress sensor 1 and displacement sensor 11, then input into four early warning modules in the stress-time database 7 and four early warning modules in the displacement-time database 9 for dynamic matching, which monitors the stress-time and displacement-time synchronously. Different from the sequential monitoring methods in the prior art, the stable state, separated layer development and instability situation of the roof can be identified by analyzing the judgments and graphs of the four early warning modules.

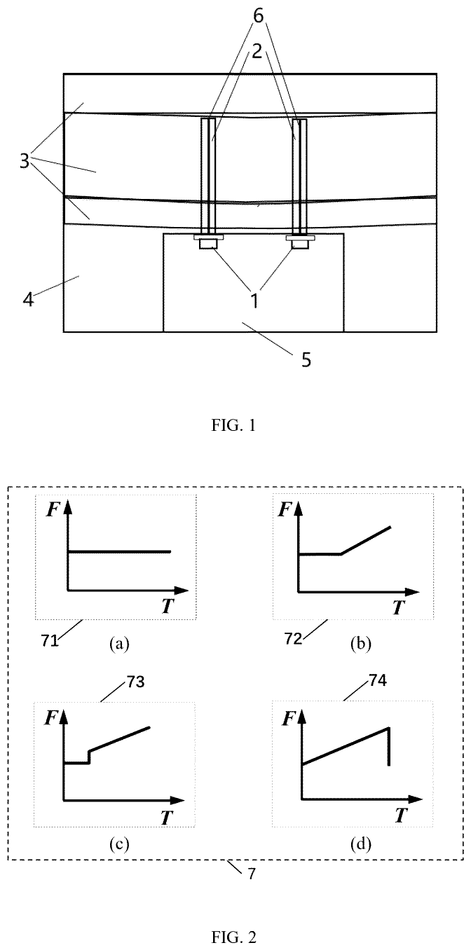

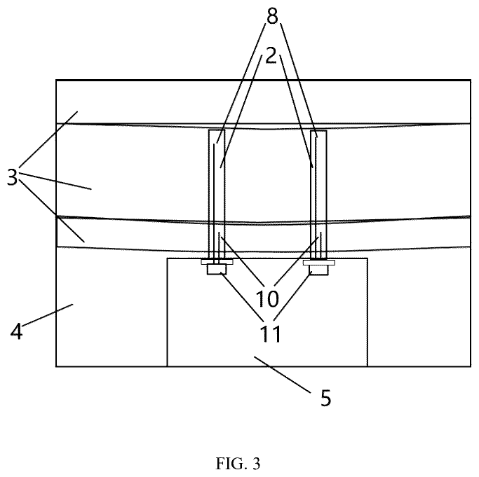

As shown in FIG. 1 to FIG. 5, the present disclosure provides a “stress-displacement” intelligent early warning method for roof disaster, including the following steps:

First, arranging a stress sensor 1 and a displacement sensor 11. In FIG. 1, tunnel 5, coal seam 4, and roof stratum 3 are shown. Arranging drilling holes 2 in the roof stratum 3 of the tunnel 5, installing anchor rods 6 in the drilling holes 2, and fixing the stress sensor 1 at the tail end of each anchor rod 6 to collect stress data in real time.

Installing a deep anchoring point 8 of displacement sensor at the deep part of the drilling hole 2, installing a shallow anchoring point 10 of displacement sensor at the shallow part of the drilling hole 2, and fixing a displacement sensor 11 outside the drilling hole 2 to collect real-time displacement data.

Second, building a stress-time database and displacement-time database 12, building corresponding databases through eight early warning modules under stress-time and displacement-time relationships, collecting stress-time and displacement-time data real time by the stress sensor 1 and the displacement sensor 11 and uploading to the data processor, carrying out dynamic matching for the uploaded data in the eight early warning modules, determining the status of the roof and evaluating it, and releasing the warning signal by the early warning release terminal 13.

The above eight early warning modules specifically include four types related to stress-time and four types related to displacement-time, as shown in FIG. 2. The four early warning modules in the stress-time database 7 include a stress stability module 71, a stress slow development module 72, a stress separated layer development module 73, and a stress separated layer instability module 74. Where in the stress stability module 71, the stress value is kept constant, which is a horizontal straight line in the graph, indicating that the roof stratum 3 are stable and risk-free; in the stress slow development module 72, the stress gradually increases from a constant state, which increases linearly from a horizontal straight line in the graph, indicating that the rock support system begins to bear stress and needs to be monitored and observed; in the stress separated layer development module 73, the stress suddenly increased, the straight line changes by leaps and bounds in the graph, indicating that the rock structure has undergone drastic changes and may pose a safety hazard; in the stress separated layer instability module 74, the stress go into dramatic decline, the straight line fall suddenly drop in the graph, indicating a failure of the support system and the possibility of imminent collapse, with the highest level of danger.

The four early warning modules in the displacement-time database 9 include an overall stability module 91, a first separated layer development module 92, a second separated layer development module 93, and a separated layer instability module 94; in the overall stability module 91, the displacement difference between the deep anchoring point and the shallow anchoring point remains constant as a whole, which is a horizontal straight line in the graph, indicating that there is no obvious separation of the roof stratum 3 and there is no danger; in the first separated layer development module 92, the displacement difference between the deep anchoring point and the shallow anchoring point slightly increases and tends to be stable, indicating that there is slight deformation in the rock layer, but it is still in a controllable state and the danger level is relatively low; in the second separated layer development module 93, the displacement difference between the deep anchoring point and the shallow anchoring point suddenly increases, which show that the curve rises by leaps and bounds in the graph, indicating rapid development of the separated layer that needs attention and an increased risk of instability; in the separated layer instability module 94, the displacement difference between the deep anchoring point and the shallow anchoring point increases exponentially, indicating an increasing trend of rock instability and a high risk of collapse.

The four early warning modules in the stress-time database 7 include a stress stability module 71, a stress slow development module 72, a stress separated layer development module 73, and a stress separated layer instability module 74, wherein the determination method for each module is as follows.

The stress stability module 71: the stress rate (ΔF/Δt)≤0.05 kN/min.

The stress slow development module 72: 0.05 MPa/min<ΔF/Δt≤0.2kN/min.

The stress separated layer development module 73: 0.2 kN/min<ΔF/Δt≤0.5 kN/min.

The stress separated layer instability module 74: ΔF/Δt >0.5 kN/min, or the stress value is obviously decreased.

ΔF/Δt represents the change in anchoring force per unit time (i.e. the slope of the curve in FIG. 2).

The four early warning modules in the displacement-time database 9 include the overall stability module 91, the first separated layer development module 92, the second separated layer development module 93, and the separated layer instability module 94. The determination method for each module is as follows.

The overall stability module 91: the displacement rate (ΔS/Δt)≤0.01 mm/min.

The first separated layer development module 92: 0.01 mm/min<ΔS/Δt≤0.1 mm/min.

The second separated layer development module 93: 0.1 mm/min<ΔS/Δt≤3 mm/min.

The separated layer instability module 94: ΔS/Δt>0.3 mm/min.

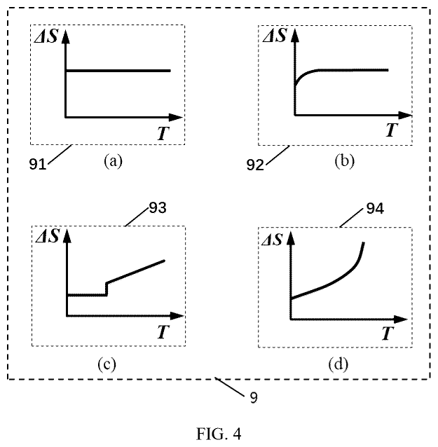

ΔS/Δt represents the change in separated layer displacement per unit time (i.e. the slope of the curve in FIG. 4).

Dynamic matching is carried out, and “stress-displacement synchronous monitoring” is realized based on real-time data collection, preprocessing, matching algorithm and state judgment.

The dynamic matching is achieved by matching real-time data with the feature curves of modules in the stress-time database and displacement-time database to identify the state of the roof. The specific process is as follows.

The data preprocessing: applying a normalization processing and moving average to the collected stress and displacement data to mitigate noise interference.

The matching algorithm: using the dynamic time warping (DTW) algorithm from existing technology, match the real-time data curve with the feature curves of the eight warning modules and calculate the degree of match.

State judgment: determining the current state of the roof based on the module with the highest matching degree and verifying the results with quantitative standards. The specific steps are as follows: firstly, single parameter judgment: matching the module in the stress-time database with stress, and matching the module in the displacement-time database with displacement to obtain the single parameter matching result. Secondly, comprehensive judgment: conducting a comprehensive evaluation of the matching results of stress and displacement: if the matching states are consistent, the current state is directly judged. If the two states are inconsistent, the state with higher risk level will be the final result.

If the stress rate matches the stress stability module 71 in the stress-time database, the stress state is stable at this time; the displacement rate matches the overall stability module 91 in the displacement-time database, where the displacement state is stable; based on comprehensive judgment, the disaster type of the roof is stable.

If the stress rate matches the stress stability module 71 in the stress-time database, the stress state is stable at this time; the displacement rate matches the first separated layer development module 92 in the displacement-time database, the displacement state is first separated layer development at this time; based on comprehensive judgment, the disaster type of roof is first separated layer development.

If the stress rate matches the stress separated layer instability module 74 in the stress-time database, the stress state is unstable at this time; the displacement rate matches the first separated layer development module 92 in the displacement-time database, the displacement state is the first separated layer development 1; based on comprehensive judgment, the disaster type of roof is stress separated layer instability.

In summary, stress-time and displacement-time can be synchronously monitored by the present disclosure to obtain more accurate judgment results. The parts not mentioned in the present disclosure can be implemented by drawing on existing technology.

The embodiments described above are merely illustrative of preferred implementations of the present invention and are not intended to limit the scope thereof. Without departing from the spirit of the invention, any modifications, equivalents, improvements, etc., made to the technical solutions of the present invention by a person skilled in the art shall fall within the scope defined by the claims of the present invention.

What is claimed is:

1. A “stress-displacement” intelligent early warning method for roof disaster, comprising following steps:
(1) establishing a stress-time database and a displacement-time database based on a relationship between stress and time of roof separation layer, as well as a relationship between displacement and the time of the roof separation layer;
(2) collecting stress-time data and displacement-time data in real time through sensors, and transmitting the collected stress-time data and the collected displacement-time data to corresponding data processors;
(3) arranging four early warning modules in the stress-time database, namely a stress stability module, a stress slow development module, a stress separated layer development module, and a stress separated layer instability module, wherein the stress stability module refers to an anchoring force not changing with time, the stress slow development module refers to the anchoring force slowly increasing with time, the stress separated layer development module refers to the anchoring force increasing in a jumping manner, and the stress separated layer instability module refers to the anchoring force decreasing abruptly;
arranging four early warning modules in the displacement-time database, namely an overall stability module, a first separated layer development module, a second separated layer development module, and a separated layer instability module, wherein the overall stability module refers to the displacement strain not changing with time, the first separated layer development module refers to the displacement strain slowly increasing and tending to stabilize, the second separated layer development module refers to the displacement strain increasing in a jumping manner, and the separated layer instability module refers to the displacement strain increasing exponentially;
(4) after processing the data through the data processors, uploading the processed data to the stress-time database and the displacement-time database for carrying out dynamic matching with the four early warning modules in each database, and then transforming the processed data into early warning signals for warning.

2. The “stress-displacement” intelligent early warning method for roof disaster according to claim 1, wherein in step (2), installing the sensors on an anchor rod or an anchor cable, and the anchor rod or the anchor cable is arranged within a roof of a tunnel; the sensors comprise a stress sensor and a displacement sensor, with the stress sensor collecting real-time stress-time data and the displacement sensor collecting real-time displacement-time data.

3. The “stress-displacement” intelligent early warning method for roof disaster according to claim 2, wherein in step (2), arranging drilling holes in a roof stratum of a tunnel, installing the anchor rod or the anchor cable in the drilling holes, and the stress sensor is fixed at a tail end of the anchor rod or the anchor cable.

4. The “stress-displacement” intelligent early warning method for roof disaster according to claim 1, wherein in step (4), transforming the processed data into early warning signals for warning through an early warning release terminal.

5. The “stress-displacement” intelligent early warning method for roof disaster according to claim 1, wherein in step (3), the stress stability module indicates that a roof stratum is stable; the stress slow development module indicates that a support system of the roof stratum is beginning to bear stress and requires monitoring and observation; the stress separated layer development module indicates that a structure of the roof stratum has undergone drastic changes with hidden dangers; the stress separated layer instability module indicates the support system is invalid with high danger level.

6. The “stress-displacement” intelligent early warning method for roof disaster according to claim 1, wherein in step (3), the overall stability module indicates that there is no obvious separation of a roof stratum; the first separated layer development module indicates that there is slight deformation in the roof stratum, but still in a controllable state; the second separated layer development module indicates that rapid development of the separated layer and the risk of instability increases; the separated layer instability module indicates an increasing trend of rock instability and a high risk of collapse.
